(19) United States
(12) Patent Application Publication
(10) Pub. No.: US 2009/0042527 A1
(43) Pub. Date: Feb. 12, 2009

(54) DYNAMIC LOW POWER RECEIVER

(75) Inventor: Ali M. NIKNEJAD, Berkeley, CA (US)

Correspondence Address: WILSON SONSINI GOODRICH & ROSATI, 650 PAGE MILL ROAD, PALO ALTO, CA, 94304-1050, US

(73) Assignee: HMicro Inc., Los Altos, CA (US)

(21) Appl. No.: 12/138,394

(22) Filed: Jun. 12, 2008

Related U.S. Application Data
(60) Provisional application No. 60/943,540, filed on Jun. 12, 2007.

(51) Int. Cl. H04B 1/06

(52) U.S. Cl. 455/234.2

(57) ABSTRACT

The present invention comprises a dynamic front end radio receiver that determines the current operating conditions and adjusts the power consumption of the receiver accordingly. In one embodiment, the receiver can detect the strength of an incoming signal and the presence of any interfering signals. The receiver includes a series of programmable blocks, where the bias of each block is adjustable. The power consumption of the overall receiver can be minimized by controlling each programmable block with a control signal. Thus, the receiver can contend with a dynamic environment, so that the performance is controlled in a manner sufficient to process the incoming signal and minimize the power dissipation necessary to achieve acceptable radio performance. An embodiment of the invention may be used in wireless radio networks for a variety of applications, such as healthcare wireless technology.

### CROSS-REFERENCE

This application claims the benefit of U.S. Provisional Application No. 60/943,540, filed Jun. 12, 2007, which application is incorporated herein by reference.

### BACKGROUND OF THE INVENTION

A lot of progress has been made to create monolithic radios for a variety of applications. This has resulted in many types of commercial radios based on various wireless standards developed by the industry. Research in semiconductor radio technology has evolved to improve high data rates and low power consumption. Conventional radio chips are often built for the worst case scenario: high power consumption regardless of signal strength or presence of blocking signals. Many radio systems dissipate higher power than that required by low power applications, such as remote wireless sensors. Some low power radio architectures are not suitable for robust communication and high volume manufacturing.

What is desired is a radio architecture system where the radio signal is adjusted dynamically based on current operating conditions. There is a need for ultra low power radio receivers that can detect the type of signal to noise scenario present and adjust the power consumption of the radio accordingly.

### SUMMARY OF THE INVENTION

An aspect of the invention is a front end radio receiver comprising a series of programmable blocks wherein each block is adjustable over a series of values by varying a control signal to the block, wherein the programmable blocks comprise a low noise amplifier (LNA) and one or more of the following: a mixer or a sampler, a local oscillation (LO) buffer, a voltage controlled oscillator (VCO), a variable gain amplifier (VGA) or a programmable gain amplifier (PGA), an intermediate frequency (IF) bandpass filter, or an analog to digital converter (ADC).

In some embodiments, the front end radio receiver comprises a computational device that determines the control signal to each of the blocks.

In some embodiments, the control signal to each of the blocks is varied based, at least partially, on a received signal strength.

In some embodiments, the computational device determines a blocking signal profile and determines the control signal to each block based on the blocking signal profile.

In some embodiments, the blocking signal profile comprises a blocking signal strength indicator (BSSI) and a list of blockers including blocker frequency and blocker signal strength.

In some embodiments, the control signal comprises a bias current or a bias voltage that modulates the DC power consumption of one or more of the programmable blocks. In some embodiments, the control signal is an analog signal. In some embodiments, the control signal is a digital signal.

In some embodiments, the radio receives an ultra-wideband signal. In some embodiments, the radio receives a narrowband signal.

In some embodiments, the front-end radio receiver is a series of programmable blocks wherein each block is adjustable over a series of values by varying a control signal to the block, wherein the programmable blocks comprise a low noise amplifier (LNA) and one or more of the following: a mixer with a local oscillation (LO) buffer, and a variable gain amplifier (VGA).

An aspect of the invention is a method for controlling power consumption of a radio that receives an input signal comprising: (a) receiving the input signal; (b) determining an input signal strength; (c) detecting a presence and characteristics of one or more blocking signals; (d) determining a set of control signals to be delivered to a series of programmable blocks based on the input signal strength and the presence and characteristics of the blocking signal, wherein the programmable blocks comprise a low noise amplifier (LNA) and one or more of the following: a mixer or a sampler, a local oscillation (LO) buffer, a voltage controlled oscillator (VCO), a variable gain amplifier (VGA) or programmable gain amplifier (PGA), an intermediate frequency (IF) bandpass filter, or an analog to digital converter (ADC); and (e) delivering a set of control signals to the programmable blocks such that the power consumption of the radio is controlled.

In some embodiments, the detecting of the presence and characteristics of a blocking signal is performed by a baseband scanner or an ADC resolution sweep.

In some embodiments, determining the set of control signals to be delivered to the programmable blocks is performed using a search table, a set of input values, and a set of constraints.

In some embodiments, the search table comprises a series of entries, each entry comprising at least a total system gain, a gain distribution comprising a gain for each of the programmable blocks, and a total power consumption.

In some embodiments, an input value comprises one or more of a required signal to noise ratio, a signal strength value, an ADC full scale power value, a blocker frequency offset value, or a blocker power level.

In some embodiments, a constraint is placed on a total gain value, a minimum detectable signal power value, a gain at a blocker frequency, or a compression point value.

In some embodiments, the entries of the search table are calculated using a method which determines an optimal set of control signals in order to minimize the power consumption while meeting the required specifications of the receiver.

In some embodiments, the method further comprises determining in step (c) that there are no blocking signals and determining the set of control signals to be delivered to the programmable blocks is performed by applying inputs for required signal to noise ratio, signal strength, and ADC full scale power comprising: (i) setting a quantization noise floor value; (ii) calculating a maximum allowed total gain value to avoid saturating the ADC, and calculating a minimum gain value required to raise the input signal above an ADC noise floor; (iii) calculating a compression point value, P_{-1dB}; (iv) searching the search table and listing as a possible solution each entry that meets the constraint of (A) a total gain value greater than or equal to a minimum total gain value and less than or equal a maximum total gain value, and (B) a minimum detectable signal power value that is greater than an input power value; (v) checking whether an entry that is listed as a possible solution has an ADC resolution that is the highest supported; (vi) repeating steps (iv) and (v) until an entry listed as a possible solution has an ADC resolution that is the highest supported; (vii) choosing an entry with the lowest total power consumption; and (viii) delivering a set of control signals to the programmable blocks from the entry chosen in step (vii).

In some embodiments, the method further comprises determining in step (c) that there is one dominant blocking signal with no in-band intermodulation product and determining the set of control signals to be delivered to the programmable blocks is performed by applying inputs for required signal to noise ratio, signal strength, ADC full scale power, blocking signal power, and blocking signal frequency comprising: (i) calculating a minimum required bits in ADC; (ii) calculating the maximum allowed total gain value to avoid saturating the ADC, a maximum allowed gain in the blocker channel, the quantization noise floor, and the minimum gain value to raise the signal out of the ADC noise floor; (iii) calculating a compression point value, P_{-1dB}, to correspond to the power of the blocking signal; (iv) searching the search table and listing as a possible solution each entry that meets the constraint of (A) a total gain value greater than or equal to the minimum total gain value and less than or equal the maximum total gain value, (B) a gain in the blocker channel that is less than or equal to the maximum allowed gain in the blocker channel, (C) a power at the blocker channel that is less than or equal to the P_{-1dB} compression point, and (D) a minimum detectable signal power value that is less than or equal to the input power value; (v) checking whether an entry that is listed as a possible solution has an ADC resolution that is the highest supported; (vi) repeating steps (iv) and (v) until an entry listed as a possible solution has an ADC resolution that is the highest supported; (vii) choosing the entry with the lowest total power consumption; and (viii) delivering the set of control signals to the programmable blocks from the entry chosen in step (vii).

In some embodiments, the method further comprises determining in step (c) that there is more than one dominant blocking signal with no in-band intermodulation product, and determining the set of control signals to be delivered to the programmable blocks is performed by applying inputs for required signal to noise ratio, signal strength, ADC full scale power, and a list of blocker power levels and frequencies wherein the power level and frequency of a largest blocker is identified, comprising: (i) calculating a minimum required bits in ADC to process the largest blocker and the input signal; (ii) calculating the maximum allowed total gain value to avoid saturating the ADC, the quantization noise floor, and the minimum gain value to raise the signal out of the ADC noise floor; (iii) calculating the compression point value, P_{-1dB}; (iv) searching the search table and listing as a possible solution each entry that meets the constraint of (A) a total gain value greater than or equal to the minimum total gain value and less than or equal the maximum total gain value, (B) a value of the gain at the blocker channel multiplied by the power of the blocker that is less than or equal to an ADC full scale power for all blockers, (C) a power level at the frequency of the largest blocker that is less than or equal to the P_{-1dB} compression point, and (D) a minimum detectable signal power value that is less than or equal to the input power value; (v) checking whether an entry that is listed as a possible solution has an ADC resolution that is the highest supported; (vi) repeating steps (iv) and (v) until an entry listed as possible solutions has an ADC resolution that is the highest supported; (vii) choosing the entry with the lowest total power consumption; and (viii) delivering the set of control signals to the programmable blocks from the entry chosen in step (vii).

In some embodiments, the method further comprises determining in step (c) that there is a high IF system with more than one dominant blocking signal and an in-band intermodulation product, and determining the set of control signals to be delivered to the programmable blocks is performed by applying inputs for required signal to noise ratio, signal strength, ADC full scale power, and a list of blocker power levels and frequencies, wherein the power level and frequency of two largest blockers is identified, comprising: (i) calculating a minimum required bits in ADC to process the largest blocker and the input signal; (ii) calculating a maximum allowed total gain value to avoid saturating the ADC, a quantization noise floor, and a minimum gain value to raise the signal out of the ADC noise floor; (iii) calculating a compression point value, P_{-1dB}, set by the two largest blockers which create the in-band distortion product; (iv) searching the search table and listing as a possible solution each entry that meets the constraint of (A) a total gain value greater than or equal to the minimum total gain value and less than or equal the maximum total gain value, (B) a value of the gain at the blocker channel multiplied by the power of the blocker that is less than or equal to the ADC full scale power for all blockers, (C) a power level at the frequency of the largest blocker that is less than or equal to the P_{-1dB} compression point, and (D) a minimum detectable signal power value that is less than or equal to the input power value; (v) checking whether an entry that is listed as a possible solution has an ADC resolution that is the highest supported; (vi) repeating steps (iv) and (v) until an entry listed as possible solutions has an ADC resolution that is the highest supported; (vii) choosing the entry with the lowest total power consumption; and (viii) delivering the set of control signals to the programmable blocks from the entry chosen in step (vii).

In some embodiments, the method further comprises determining in step (c) that there is a low IF system or a direct conversion system with more than one dominant blocking signal and an in-band intermodulation product, and determining the set of control signals to be delivered to the programmable blocks is performed by applying inputs for required signal to noise ratio, signal strength, ADC full scale power, and a list of blocker power levels and frequencies, wherein the power level and frequency of two largest blockers is identified, comprising: (i) calculating the minimum required bits in ADC to process the largest blocker and the input signal; (ii) calculating the maximum allowed total gain value to avoid saturating the ADC, the quantization noise floor, and the minimum gain value to raise the signal out of the ADC noise floor; (iii) calculating a compression point value, P_{-1dB}, set by the two largest blockers which create the in-band distortion product; (iv) searching the search table and listing as a possible solution each entry that meets the constraint of (A) a total gain less than the maximum total gain value, (B) a gain in the blocker channel that is less than the maximum allowed gain in the blocker channel, (C) a power level at the frequency of the largest blocker that is less than the P_{-1dB} compression point, (D) a minimum detectable signal power value that is less than the input power value, and (E) a voltage second-order intercept point value that is greater than a required minimum voltage second-order intercept point value; (v) checking whether an entry that is listed as a possible solution has an ADC resolution that is the highest supported; (vi) repeating steps (iv) and (v) until an entry listed as possible solutions has an ADC resolution that is the highest supported; (vii) choosing the entry with the lowest total power consumption; and (viii) delivering the set of control signals to the programmable blocks from the entry chosen in step (vii).

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram of an exemplary embodiment of a dynamic front-end radio comprising programmable building blocks in accordance with the present invention.

FIG. 2 is a block diagram of an embodiment of the invention with a cascade of several blocks that are each described by gain, noise figure and intercept point in accordance with the present invention.

FIG. 3 is a block diagram of an embodiment of the invention, comprising an LNA, mixer, VCO and ADC in accordance with the present invention.

FIG. 4 is a process flow diagram of a process according to the invention for choosing control signals where no blocking signal is detected.

FIG. 5 is a process flow diagram of a process according to the invention for choosing control signals where one blocking signal is detected.

FIG. 6 is a process flow diagram of a process according to the invention for choosing control signals where multiple blocking signals are detected.

FIG. 7 illustrates a wireless sensor (μsensor) network in accordance with the present invention.

FIG. 8 is a block diagram of a mostly digital ultra-wideband (UWB) radio.

FIG. 9 is a block diagram of a narrowband radio including a synthesizer.

FIG. 10 is a diagram of a Cognitive Universal Radio (COGUR), a front-end of a software defined radio.

### DETAILED DESCRIPTION OF THE INVENTION

The current invention comprises a dynamic front end radio receiver that controls and adjusts power consumption in response to current operating conditions, such as the strength of an incoming signal and the presence of blocking signals. The dynamic front end radio receiver comprises a series of programmable blocks, where the bias of each block is adjustable over a discrete set of values. In order to optimize receiver performance and control power dissipation, the incoming signal strength and strength of interfering signals is detected. A microprocessor assesses the radio environment in light of the signal strength and blocking signals, and utilizes stored information and sets of instructions to determine and set the control signal, e.g. bias current for each programmable block, thus adjusting the performance of each block. By controlling each programmable block with a control signal, the power consumption of the overall receiver can be minimized. The receiver performance can be optimized to contend with a dynamic environment, so that in any given situation, the performance can be controlled such that it is just sufficient to process the signals present at the antenna input, thus minimizing the amount of power necessary to achieve such performance.

In one embodiment of the invention, the dynamic front end radio receiver comprises a series of programmable blocks. The adjustment of the gain over each programmable block results in the lowest power consumption for a given operating condition to produce acceptable radio performance. Acceptable radio performance comprises, for example, meeting the signal to noise plus distortion ratio (SNDR) for a given modulation scheme. Low power consumption or dissipation involves low energy consumption and a longer battery life for the radio.

For a radio receiver, the following performance specifications can be used in determining the performance of the system: LNA Gain, Noise Figure (NF), and Linearity (IIP₂, IIP₃), Mixer Gain, Noise Figure (NF), and Linearity (IIP₂, IIP₃), VCO Phase Noise, LO Power (Voltage Swing), VGA/PGA Gain Setting, Noise Figure (NF), and Linearity (IIP₂, IIP₃), and Baseband Filter Bandwidth. In most receivers, these specifications for the blocks are held constant (with the exception of the VGA/PGA gain setting) and specified for the worst-case scenario, typically dictated by the classic near/far problem. The noise figure can be determined by long-range communication requirements whereas the IIP₃ is generally set by the power of expected blocking signals or interfering signals which operate close to the desired frequency. The VCO phase noise for the receiver is largely determined by the reciprocal mixing of phase noise with blocking tones. The LO power is generally set high enough to provide optimal conversion gain and noise figure in the mixer. The baseband filter bandwidth and resolution is also usually dictated by worst case scenarios, sufficient attenuation to reject out of channel and out of band signals and sufficient resolution so that a weak signal can be detected in the presence of quantization noise. While these settings result in a robust receiver, the power consumption tends to be dominated by these difficult and often contradicting specifications. For mobile applications where the radio is operating with a battery, this results in short operating life.

In one embodiment of the invention, the system comprises a set of programmable blocks that are adjusted dynamically based on current operating conditions. In conventional radio architecture, the received signal strength has been used in some cases to program the LNA gain. For instance, LNA's can have a simple two gain setting feature. In one mode, the gain is at a maximum, whereas in the other mode, the LNA gain is low and often attenuating. The linearity of the LNA generally varies in accordance with the gain setting. For instance, high linearity is achieved in attenuation mode. In one embodiment of the invention, the gains of other blocks (other than the LNA) are changeable. For example, the gain of the mixer will be adjusted by changing the LO power, which results in great power savings. This is especially true in passive mixers where the conversion gain and noise figure is a strong function of the LO drive. The power dissipation is strongly dependent on the LO drive since the LO must drive capacitive parasitics at high frequency, where CV²f losses dominate. Adjustment of the gain at the front-end, rather than the back-end, greatly relaxes the linearity requirements of the baseband building blocks (filters, VGAs), which results in lower power consumption for the entire system. This is favorable when the receiver is operating in an interference limited environment, rather than a noise limited environment. As used herein, when controlling the gain with control signals such as bias current is described, it is understood that in some cases properties of the programmable block other gain can be adjusted and controlled by the control signals in order to implement the dynamic radio of the present invention.

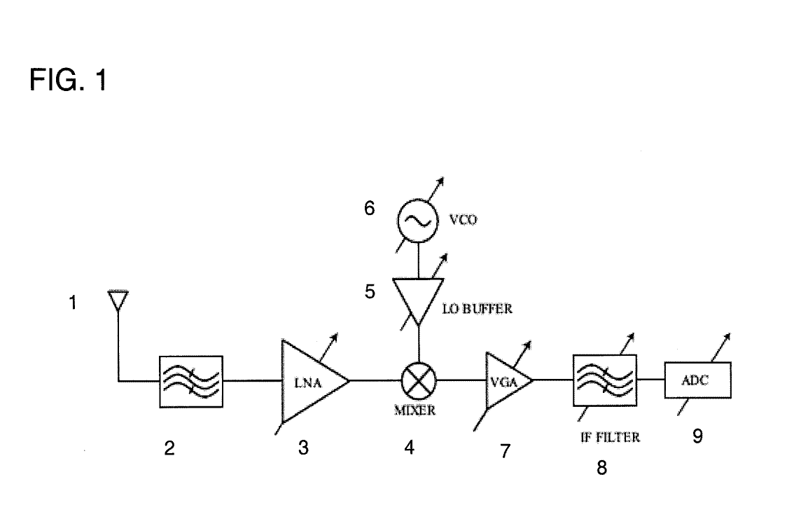

FIG. 1 shows an exemplary embodiment of the invention. The dynamic front end radio comprises programmable blocks, where the control signal such as the bias current can be adjusted to save power, while compromising noise figure, linearity, and gain in each block. In some cases the power dissipation of the individual block is controlled by the control signal. In some cases, the control signal adjusts the performance of a programmable block such that, while the power dissipation of that particular block is not lowered, the control of that block lowers the power dissipation of the system as a whole. The programmable blocks shown comprise a low noise amplifier (LNA) 3, a mixer or sampler 4, a local oscillation (LO) buffer 5, a voltage controlled oscillator (VCO) 6, a variable gain amplifier (VGA) or programmable gain amplifier (PGA) 7, an intermediate frequency (IF) bandpass filter 8, and an analog to digital converter (ADC) 9. The invention may include an antenna 1 and additional non-programmable front end filters 2. In other embodiments, not all of the blocks shown will be programmable. In general, at least the LNA and one other block are programmable blocks.

The radio receivers of the invention generally comprise a programmable LNA 3. The LNA comprises a type of electronic amplifier or amplifier used in communication systems to amplify very weak signals captured by an antenna. The LNA can be located very close to the antenna to minimize losses in the feedline and may be located in the front-end of a radio receiver circuit. An LNA may be used to reduce the noise of all subsequent stages by the gain of the LNA, and the noise of the LNA is injected directly into the received signal. An LNA can also be used to boost the desired signal power while adding as little noise and distortion as possible so that the retrieval of the signal is possible in later stages in the system.

In some embodiments of the invention, a programmable block comprises a mixer 4. A mixer can act as a nonlinear or time-varying circuit or device that accepts as its input two different frequencies and presents as its output a mixture of signals at several frequencies. These signals may include a sum of the frequencies of the input signal, the difference between the frequencies of the input signals, or both original input frequencies which are often considered parasitic and are filtered out in subsequent filter stages. In some cases, a mixer can be a down-conversion mixer or frequency conversion block. A linearity periodically time-varying circuit can be used as a frequency conversion block. Another aspect of the invention may involve a sampler. A sampler may be used to extract samples from a continuous signal and reduce the continuous signal to a discrete signal. A sampler may perform a similar function as a mixer when the signal is sub-sampled.

In some embodiments of the invention, a programmable block comprises a local oscillator (LO) 5. A local oscillator comprises a device used to generate a signal which is beat against the signal of interest to mix it to a different frequency. The oscillator produces a signal which is injected into the mixer along with the signal from the antenna in order to effectively change the antenna signal by heterodyning with it to produce the sum and difference of that signal one of which will be at the intermediate frequency which can be handled by the IF amplifier.

In some embodiments of the invention, a programmable block comprises a voltage controlled oscillator (VCO) 6. In some embodiments, a VCO comprises an electronic oscillator designed to be controlled in oscillation frequency by a voltage input. The frequency of oscillation is varied by the applied DC voltage, while modulating signals may also be fed into the VCO to cause frequency modulation or phase modulation.

In another embodiment of the invention, a programmable block comprises a variable gain amplifier (VGA) 7. The VGA comprises an electronic amplifier that varies its gain depending on a control voltage. In another embodiment of the invention, the block comprises a programmable gain amplifier (PGA). A PGA can be an operational amplifier which has internal gain settings that can be controlled by digital or analog inputs on the device.

In another embodiment of the invention, a programmable block comprises an interference frequency (IF) bandpass filter 8. In one embodiment, a band-pass filter comprises a device that passes frequency within a certain range and rejects frequencies outside the range.

In one embodiment of the invention, a programmable block comprises an analog to digital converter (ADC) 9. An ADC comprises an electronic integrated circuit, which converts continuous signals to discrete digital numbers. The ADC can be an electronic device that converts an input analog signal or current to a digital number.

One aspect of the invention is a front end radio receiver comprising a series of programmable blocks wherein each block is adjustable over a series of values by varying a control signal to the block, wherein the programmable blocks comprise a low noise amplifier (LNA) and one or more of: a mixer or sampler; a local oscillation (LO) buffer; a voltage controlled oscillator (VCO); a variable gain amplifier (VGA) or programmable gain amplifier (PGA); an intermediate frequency (IF) bandpass filter, or an analog to digital converter (ADC). The front end radio can have any suitable combination of the programmable blocks described herein. For example, the programmable blocks could comprise an LNA and a mixer or sampler, an LNA and an LO buffer, an LNA and a VCO, an LNA and a VGA or PGA, an LNA and an intermediate frequency (IF) bandpass filter, or an LNA and an ADC. In some embodiments, the front end radio will have the programmable blocks of at least an LNA, an ADC and a mixer; an LNA, an ADC and an LO buffer; an LNA, an ADC and a VCO; an LNA, an ADC and a VGA or PGA; or an LNA, an ADC and frequency (IF) bandpass filter. Other combinations of suitable programmable blocks are also an aspect of the present invention.

In some cases, the front end radio receiver of claim 1 further comprises a computational device that determines the control signal to each of the blocks. The computational device can be a microprocessor or other device capable of carrying out instructions as described herein.

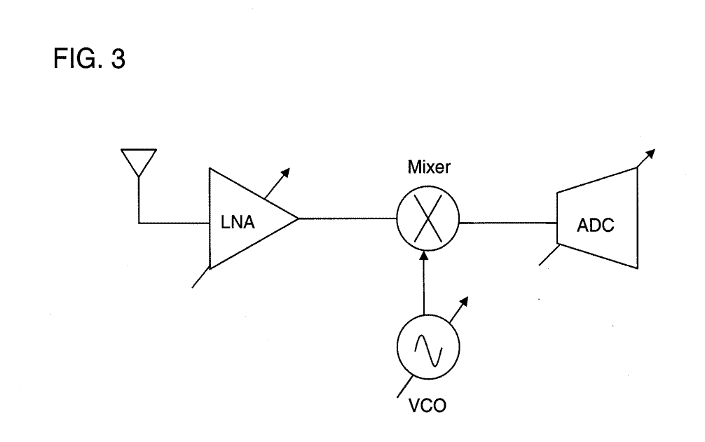

In some embodiments, the invention may include subsets of the programmable blocks and connected in differing orders than that shown in FIG. 1. For example, an embodiment of the invention may comprise only a programmable LNA, a programmable mixer, a programmable VCO, and a programmable ADC, as shown in FIG. 3. In another embodiment of the invention, some of the blocks may be programmable and others are fixed. For instance, the LNA and VGA may be programmable, but the other blocks in the system are not programmable.

In one aspect of the invention, the radio receiver device receives the incoming signal via the antenna 1 and derives a blocking signal profile estimation. A blocking signal profile comprises blocking signals in the bandwidth of the incoming signal. Blocking signals comprise any signals present at the input of the receiver with strength greater than the desired channel (P_{B1}>P_{B2}>P_{B3}> . . . >Pᵢₙ). A blocking signal may be also called a blocker, interfering signal, or unwanted signal in the same bandwidth as the incoming signal. A blocking signal profile may include no blocking signals, one blocking signal or multiple blocking signals. The following signals are derived from the incoming signal and used in the algorithm: radio frequency received signal strength indicated (RF-RSSI) (Pᵢₙ), blocking signal strength indicator (BSSI) (P_{B}), an ordered list of blockers sorted by blocker power (P_{B1}, P_{B2}, . . . ), and the corresponding frequency of the blocking signals (f_{B1}, f_{B2}, . . . ). The blockers occur at offsets from the desired input frequency (|f_{Bk}−f₀|>0). P_{B} is the effective power of the blockers which captures the receiver desensitization.

In one embodiment of the invention, a baseband scanner is used to determine the blocker profile. It is assumed that the blocker profile is relatively static within the time scale of the technique employed. A receiver may be used to scan each channel of the RF spectrum, and the output may be either quantized and stored or a simple power detector can be used to calculate the power in the band. Since this operation must be done quickly, the phase-locked loop (PLL) bandwidth can be set to allow fast channel switching. In order to process the signals, a highly linear front-end may be employed. To avoid the power penalty, this front-end is duty cycled. Since blocking signals are large, this receiver does not need an LNA or many gain stages. In one aspect, the RF spectrum is simply down converted to baseband using a single-sideband mixer with high linearity. A passive mixer is employed to realize high linearity in the down-conversion process. This scanner can be realized as a separate receiver or the main receiver can be reconfigured to perform this function. The time to perform this operation is limited by the settling time of the PLL.

In another embodiment of the invention, the blocker profile may be found by an ADC resolution sweep. The baseband bandwidth can be set to capture the entire channel and the ADC resolution sweeps from low resolution to high resolution mode in several steps. At a given resolution settings of N-bits, the dynamic range of the ADC is approximately 6.02×N (dB), which means that only signals above the quantization noise floor of the ADC can be properly detected. As the dynamic range is increased N+1 bits, more signal powers can be detected. For example, the power detector output will vary with the number of detected signals and thus as the BB RSSI increases, indicating the presence of a new interfering signal within 6.02 dB power level of the previously detected blocker. The advantage of this approach is that the PLL settling time does not affect the time it takes to scan the band of interest. Instead, the settling time of the ADC is the most important factor.

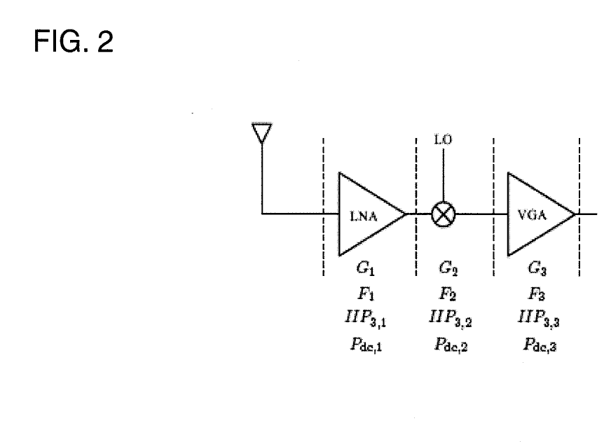

One aspect of the invention includes a gain setting or control signal setting algorithm. The algorithm can be reduced to a series of instructions for a microprocessor or other computing element in order to determine the appropriate control signal to send to the programmable blocks under a given set of conditions. In one embodiment, given the frequency and power level for the blockers, all in-band distortion components are calculated to determine the required linearity of the receiver in order to operate under the given scenario. Each block k in the receiver can be described by its gain Gₖ, noise figure Fₖ, and it's linearity IIP3ₖ, as shown schematically in FIG. 2. It is assumed that for each block, the bias can take on a set of discrete values which results in gains G_{k,1}, G_{k,2}, . . . , G_{k,Mk}, noise figures F_{k,1}, F_{k,2}, . . . , F_{k,Mk}, intercept points IIP3_{k,1}, IIP3_{k,2}, . . . , IIP3_{k,Mk}, and DC power consumption P_{k,1}, P_{k,2}, . . . , P_{k,Mk}. The mixer block subsumes the VCO/LO chain, as the LO buffer power level (or voltage level) changes the effective noise figure, linearity, and conversion gain of the mixer. The optimal set of bias points is determined in order to minimize the power consumption, while meeting the required specifications of the receiver. The final block in the receiver chain can be the analog-to-digital converter (ADC), which has an effective resolution of N_{bits}. In one aspect, this process is also dynamic and programmable, and a lower resolution of the converter corresponds to lower power consumption. In another embodiment of the invention, the effective number of bits can be programmed through several mechanisms, such as including more parallel/serial stages in a flash or pipeline converter or by varying the oversampling ratio or modulator order.

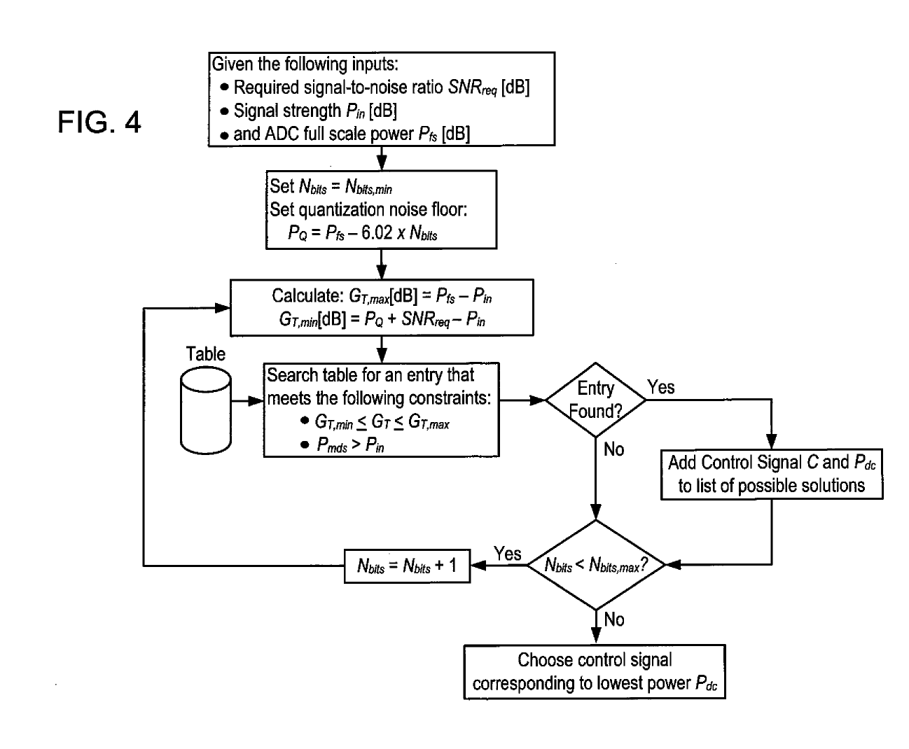

In one aspect of the invention, the radio receiver detects that there are no blocking signals present. The following process describes one method of the invention for sending the control signals to the programmable blocks to dynamically optimize performance where no blockers are present. The flow diagram shown in FIG. 4 illustrates the process. The input power is Pᵢₙ, which means that the receiver can be optimized to process the desired channel with little regard to the linearity of the receiver. This assumes that the incoming signal is relatively weak, or the signal power is below the 1-dB compression point (Pᵢₙ<P−_{1dB}). A compression point comprises the output level at which the actual gain departs from the theoretical gain 1-dB. The gain of the receiver needs to be only large enough to bring the incoming signal to the full-scale (FS) power of the ADC input P_{fs}. The resolution of the ADC is large enough so that the quantization noise is below the required signal-to-noise ratio (SNR) for the system, SNR_{req}, which is determined by the modulation type (typically about 10-20 dB). The overall gain can therefore be written as:

$${G}_{T} = {G}_{1} {G}_{2} … {G}_{N} \geq \frac{{P}_{fs}}{{P}_{i n}} = \frac{{P}_{Q}}{{P}_{i n}} {SNR}_{req}$$

where P_{Q} is the quantization noise floor of the ADC. An additional constraint comes from the noise of the system, which must sum at the input of the ADC to be below the quantization noise floor. The overall noise of the system at baseband can be written as:

Nₒᵤₜ=((F₁−1)Nₛ+Nₛ)G₁ . . . G_{N}+ . . . (F_{N}−1)NₛG_{N}<P_{Q}

An alternative perspective is that for each gain setting profile G_{k,1}, . . . , G_{k,Mk}, there is a corresponding noise figure profile which results in a minimum detectable signal (MDS), which is a function of the bandwidth and system noise figure. The system noise figure for a matched system is given by the well known relation:

$${F}_{sys} = {F}_{1} + \frac{{F}_{2} - 1}{{G}_{1}} + \frac{{F}_{3} - 1}{{G}_{1} {G}_{2}} + …$$

The minimum detectable signal is at least SNR_{req} above the noise floor of the system:

P_{MDS}=kT·B·F_{sys}·SNR_{req}

Table 1 shows the format of a search table for determination of optimal power consumption for meeting a given specification.

TABLE 1

| | | | | | |
|---|---|---|---|---|---|
| . | | | | | |
| . | | | | | |
| . | | | | | |
| C₁ | G_{T,1} | [G₁, G₂, . . . G_{N}]¹ | P_{MDS}¹ | P_{-1dB}¹ | P_{DC}¹ |
| C₂ | G_{T,1} | [G₁, G₂, . . . G_{N}]² | P_{MDS}² | P_{-1dB}² | P_{DC}² |
| C₃ | G_{T,1} | [G₁, G₂, . . . G_{N}]³ | P_{MDS}³ | P_{-1dB}³ | P_{DC}³ |
| C₄ | G_{T,2} | [G₁, G₂, . . . G_{N}]⁴ | P_{MDS}⁴ | P_{-1dB}⁴ | P_{DC}⁴ |
| . | | | | | |
| . | | | | | |
| . | | | | | |

In one aspect of the invention, a table in memory can be constructed to determine the set of gains that results in the lowest power consumption, where each row corresponds to a particular system control vector Cₖ, the total system gain G_{T,k}, which is given by a particular gain distribution {G_{k,1}, G_{k,2}, . . . , G_{k,Mk}}, which results in a compression point P−_{1dB} and an MDS of P_{MDS,k,j}, and a total power consumption of P_{dc,k,j}. The format of the table is shown in Table 1. The table is sorted by the DC power consumption. In this aspect, the lowest DC power consumption can be found by selecting the first row that provides the required gain while meeting the noise requirement, P_{MDS}>Pᵢₙ. At a particular ADC resolution N_{bits}, the minimum required gain raises the input signal above the noise floor, or G_{T,min}=P_{Q}×SNR_{req}/Pᵢₙ, where P_{Q} is the quantization noise of the ADC. The maximum allowed gain is given by G_{T,max}=P_{fs}/Pᵢₙ.

In another aspect, the table for each ADC resolution is used to find the global minimum power consumption. If there are no blocking signals present, there is no possibility of reciprocal mixing in the receiver, so the phase noise can be set for the lowest power consumption. The algorithm begins with the following inputs: required signal-to-noise ratio SNR_{req} [dB], signal strength Pᵢₙ [dB], and ADC full scale power P_{fs} [dB]. Next, the algorithm sets the N_{bits} equal to the N_{bits,min}. The quantization noise floor is determined: P_{Q}=P_{fs}−6.02*N_{bits}. Next, the maximum allowed gain, G_{T,max}[dB]=P_{fs}−Pᵢₙ, to avoid saturating the ADC is calculated, and the minimum required gain to bring the signal out of the quantization noise floor of the ADC is determined: G_{T,min}[dB]=P_{Q}+SNR_{req}−Pᵢₙ. Next, the table is searched for an entry that meets the following constraints: G_{T,min}≦G_{T,max} and P_{mds}>Pᵢₙ. If an entry is found, the control vector Cₖ and P_{dc,k} is added to the list of possible solutions. Then, the algorithm is used to determine if the current ADC resolution is the highest supported: N_{bits}<N_{bits,max}. If not, the algorithm continues increasing the ADC resolution and repeating the above steps. Finally, when the ADC resolution is higher than the maximum allowed, the control vector corresponding to lowest power P_{dc} is chosen.

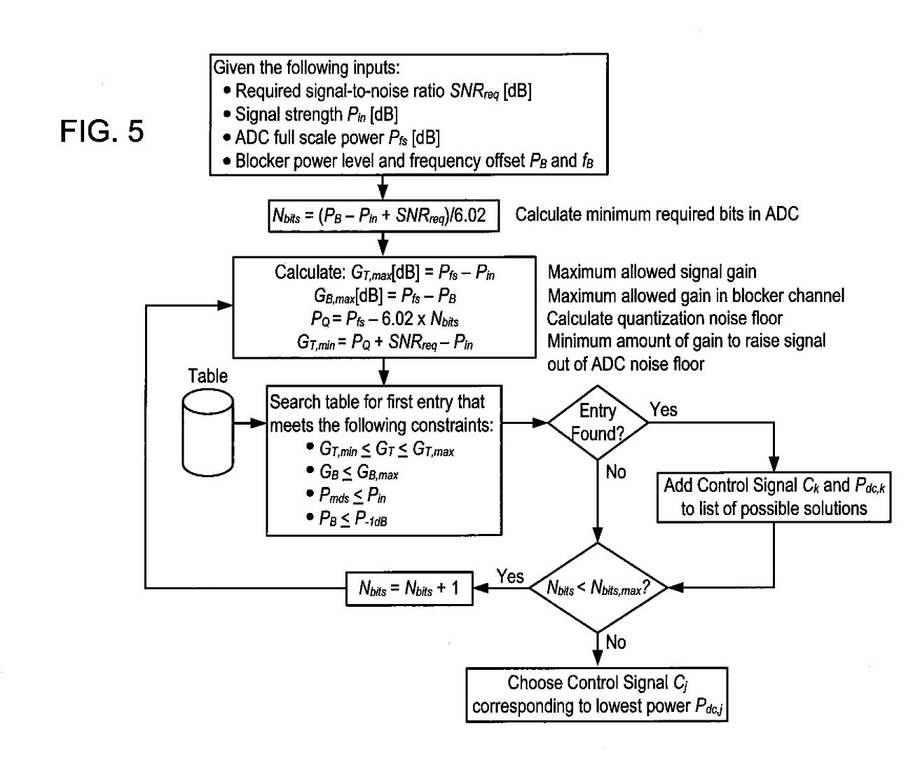

In one aspect of the invention, the radio receiver detects that there is only one blocking signal present with power P_{B}. The following process describes one method of the invention for sending the control signals to the programmable blocks to dynamically optimize performance where one blocking signal is present. The process is also summarized in flow diagram shown in FIG. 5. To ensure proper processing of the input signal and the blocker, the gain of the system must be adjusted to ensure the blocker does not saturate any stages, the resolution of the ADC must be increased to handle the dynamic range of the blocker and the input signal, and the linearity of overall system must be sufficient to avoid desensitization by the blocker, which is tantamount to setting the P_{-1dB} of the entire system to correspond to approximately the signal power of the blocker. The P_{-1dB} of the entire system can be estimated using the following equation:

$${P}_{- 1 dB , sys} \approx {P}_{IIP 3 , sys} - 9.6 dB$$

$$where$$

$$\frac{1}{{IIP}_{3 , sys}} = \frac{1}{{IIP}_{3 , 1}} + \frac{{G}_{1}}{{IIP}_{3 , 2}} + \frac{{G}_{1} {G}_{2}}{{IIP}_{3 , 3}} + … \frac{{G}_{1} {G}_{2} … {G}_{N - 1}}{{IIP}_{3 , N}}$$

which assumes negligible second-order interaction, which follows if the amplifiers are narrowband and/or AC coupled.

To determine the optimal gain settings, the total required gain is found in order to avoid saturating the ADC:

$${G}_{B , max} = {G}_{1} ( {f}_{B} ) \cdot {G}_{2} ( {f}_{B} ) … {G}_{N} ( {f}_{B} ) < \frac{{P}_{{f}_{s}}}{{P}_{B}}$$

where the gains are evaluated at the frequency of the blocker f_{B}, which is usually lower than the gain at the center of the channel,

G_{T,max}=G₁(f₀)·G₂(f₀) . . . G_{N}(f₀)

but must be chosen so that the input Pᵢₙ does not saturate the ADC:

G_{T,max}Pᵢₙ<P_{fs}

Table 2 shows the format of search table for determination of optimal power consumption for meeting a given specification including the achievable linearity and cumulative gains at blocker frequencies.

TABLE 2

| | | | | | | | | |
|---|---|---|---|---|---|---|---|---|
| . | | | | | | | | |
| . | | | | | | | | |
| . | | | | | | | | |
| Cₖ | G_{T,1} | G_{B,1} | . . . | G_{B,k} | [G₁, | P_{MDS}¹ | P_{-1dB}¹ | P_{DC}¹ |
| | | | | | G₂, . . . G_{N}]¹ | | | |
| . | | | | | | | | |
| . | | | | | | | | |
| . | | | | | | | | |

The algorithm is used to calculate the minimum required resolution of the ADC. The required dynamic range is P_{B}(dB)−Pᵢₙ(dB)+SNR_{req}(dB). This ensures that the incoming signal is larger than the quantization noise floor (which can be estimated by assuming the dynamic range scales as 6.02N_{bits}). For example, Table 1 is augmented to include the cumulative gain at the blocking frequency offsets fₖ (Table 2):

G_{B,k}=G₁(f_{B,k})·G₂(_{fB,k}) . . . G_{N}(f_{B,k})

In one embodiment, the algorithm uses the following inputs: required signal-to-noise ratio SNR_{req} [dB], signal strength Pᵢₙ [dB], ADC full scale power P_{fs} [dB], blocker power level and frequency offset P_{B} and f_{B}. Next, the minimum required bits in ADC is calculated with the following equation:

N_{bits}=(P_{B}−Pᵢₙ+SNR_{req})/6.02

The quantization noise floor is calculated by the following equation: P_{Q}=P_{fs}−6.02×N_{bits}. The maximum allowed signal gain is determined by the equation: G_{T,max}[dB]=P_{fs}−Pᵢₙ. The maximum allowed gain in the blocker channel is determined by the equation: G_{B,max}[dB]=P_{fs}−P_{B}. The minimum amount of gain to raise the desired signal out of ADC noise floor is calculated by the equation: G_{T,min}=P_{Q}+SNR_{req}−Pᵢₙ. The algorithm then searches the table for the first entry with gain G_{T} that meets the following constraints: G_{T,min}≦G_{T}≦G_{T,max}, G_{B}≦G_{B,max}, P_{mds}≦Pᵢₙ, and P_{B}≦P−_{1dB}. If an entry is found, the control vector Cₖ and P_{dc,k} is added to the list of possible solutions. Next, the algorithm is used to determine if the current ADC resolution is lower than the maximum allowed: N_{bits}<N_{bits,max}. If the current ADC-resolution is lower than the maximum allowed, the ADC resolution is incremented, and the above steps are repeated by the algorithm. Finally, when the ADC resolution is higher than the maximum allowed, a control vector Cⱼ is chosen corresponding to lowest global power P_{dc,j}.

In one aspect of the invention, the first entry that satisfies the required criteria results in the lowest power consumption. Since there are blocking signals present, reciprocal mixing occurs in the receiver, so the phase noise can be set for the lowest power consumption of the VCO while ensuring that the phase noise down-converted in-band is below the required threshold (SNR_{req}). The phase noise of the VCO as a function bias current at the blocker offset frequencies is stored in a table to facilitate this calculation.

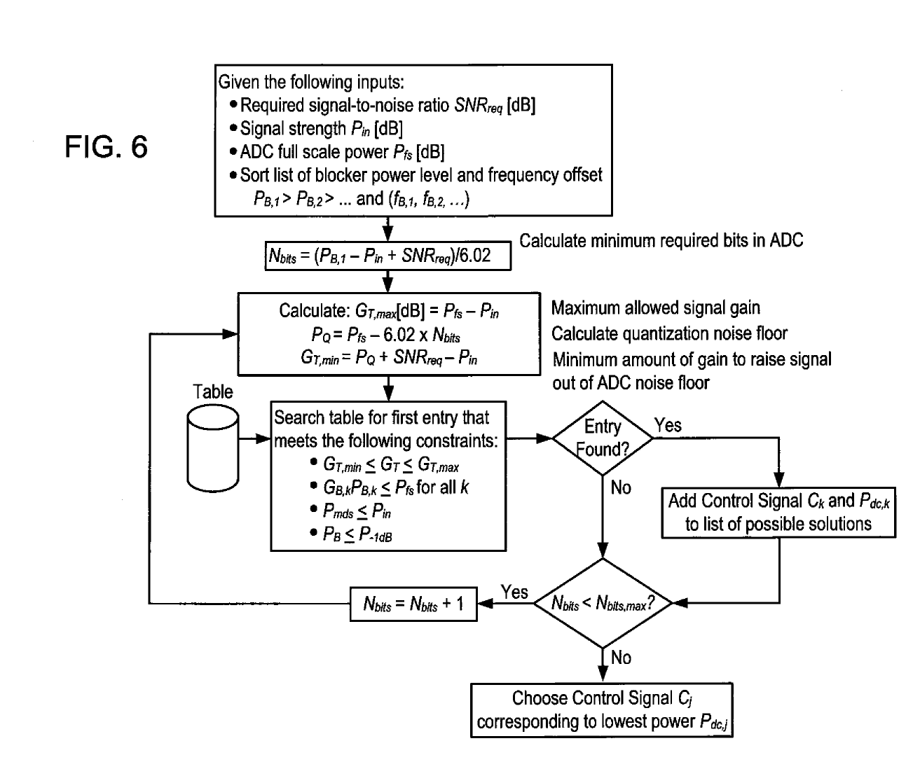

In another aspect of the invention, the radio receiver detects that there are K blockers but that the frequency of the blockers is such that there are no intermodulation products that fall in-band. The following process describes one method of the invention for sending the control signals to the programmable blocks to dynamically optimize performance where more than one blocking signal is present. The process is summarized in flow diagram shown in FIG. 6. For instance, for two blockers, |Mω₁±Nω₂|6≠ω₀, for all integers N+M=P, where P is the power of the highest order non-linearity in the receiver. We examine the distortion products pairwise

$$( \begin{matrix}K \\ 2\end{matrix} ) .$$

Since the IF bandwidth generally rolls off with increasing frequency distance from the band center, higher frequency blockers are attenuated more, complicating the picture. For simplicity, though, it is assumed that all blockers experience the same gain so that the above algorithm can be utilized virtually unchanged as long as we select P_{B}=max(P_{B,1}, P_{B,2}, . . . ). The above procedure can be modified to obtain a more accurate optimal. The following inputs are used: required signal-to-noise ratio SNR_{req} [dB], signal strength Pᵢₙ [dB], ADC full scale power P_{fs} [dB], sorted list of blocker power levels and frequency offsets P_{B,1} [symbol] P_{B,2}> . . . and (f_{B,1}, f_{B,2}, . . . ).

Next, the minimum required bits in ADC to process the largest blocker and the input signal are calculated: N_{bits}=(P_{B,1}−Pᵢₙ+SNR_{req})/6.02. This implies that the quantization noise floor is given by P_{Q}=P_{fs}−6.02×N_{bits}. The maximum allowed signal gain to avoid saturating the ADC is given by G_{T,max}[dB]=P_{fs}−Pᵢₙ. Likewise, the minimum amount of gain to raise signal out of ADC noise floor is given by G_{T,min}[dB]=P_{Q}+SNR_{req}−Pᵢₙ. In one aspect of the invention, the table is searched for the first entry that meets the following constraints: G_{T,min}≦G_{T}≦G_{T,max}, G_{B,k}P_{B,k}≦P_{fs} for all k, P_{mds}≦Pᵢₙ, and P_{B,1}≦P_{-1dB}. In one aspect, the gain constraint is imposed K times for each blocker. In practice, this additional constraint is easy to check because most systems have a finite number of channels, and the table can be easily modified to include the total system gain G_{T} as before, but also the total gain at each blocker frequency offset, G_{B,1}, G_{B,2}, . . . . This process is repeated for each possible ADC resolution N_{bits}>N_{bits,min}.

Reciprocal mixing in the receiver is a concern, since there are blocking signals present, so the phase noise can be set for the lowest power consumption of the VCO, while ensuring that the phase noise down-converted in-band is below the required threshold (SNR_{req}). In one aspect, a table of phase noise at the blocker offset frequencies as a function of bias currents can be used to determine the lowest power consumption that meets the required SNR. In this step, the phase noise contribution from all blockers is summed in RMS to determine the in band noise contribution.

In one aspect of the invention, the radio receiver uses a high IF system, and two blockers are present that create in-band intermodulation products. The following process describes one method of the invention for sending the control signals to the programmable blocks to dynamically optimize performance where two or more blockers are present that create an in-band intermodulation product. If the blockers lie at frequency offsets in such a manner as to create in-band distortion products, then the power of the intermodulation products must lie below the noise floor of the system, or IM₃>SNR_{req}. It is assumed that amplifier stages are AC coupled or fully balanced, so that only in-band distortion products are important, which means even-powered distortion terms are neglected.

In some embodiments of the invention, when two strong blocking signals are present, the distortion products appear with magnitude:

$${V}_{d} = \frac{3}{4} {α}_{3} {V}_{b 1}^{2} {V}_{b 2}$$

where V_{b1} is the stronger blocking signal (the symmetric term can therefore be dropped). Referring this signal to the input of the amplifier,

$${V}_{di} = \frac{3}{4} \frac{{α}_{3}}{{α}_{1}} {V}_{b 1}^{2} {V}_{b 2}$$

where it is assumed that the blocking signals are not strong enough to desensitize the receiver. It is desired that this signal lie below the MDS, V_{di}<V_{mds}

$$\frac{3}{4} \frac{{α}_{3}}{{α}_{1}} {V}_{b 1}^{2} {V}_{b 2} < {V}_{mds} = \frac{{V}_{i n}}{S N {R}_{req}}$$

Solving this equation for the ratio a₃/a₁ gives the required linearity of the system. The 1-dB compression point of a system is given by:

$${V}_{- 1 dB} = \sqrt{\frac{4}{3} \vert \frac{{α}_{1}}{{α}_{2}} \vert} \sqrt{0.11} = {V}_{{IIP}_{3}} - 9.6 dB$$

The algorithm can be used with the simple modification that the P_{-1dB} requirement is set by the two largest blockers which create in-band distortion.

In one aspect of the invention, the radio receiver detects that there are N blockers present and determines a m'th Order Non-Linearity. The following process describes one method of the invention for sending the control signals to the programmable blocks to dynamically optimize performance where there are N blockers present and determines a m'th Order Non-Linearity. The effect of an m'th order non-linearity on an input of N tones is represented as follows:

$${y}_{m} = {( {\sum }_{n = 1}^{N} {A}_{n} cos {ω}_{n} t )}^{m}$$

$${y}_{m} = {( {\sum }_{n = - N}^{N} \frac{{A}_{n}}{2} {e}^{{ω}_{n} t} )}^{m}$$

where we assumed that A₀≡0 and ω₋ₖ=ωₖ. The product of sums can be written as sum of products

$$= {\sum }_{{k}_{1} = - N}^{N} {\sum }_{{k}_{2} = - N}^{N} … {\sum }_{{k}_{m} = - N}^{N} \frac{{A}_{{k}_{1}} {A}_{{k}_{2}} … {A}_{{k}_{m}}}{{2}^{m}} \times {e}^{j ( {ω}_{{k}_{1}} + {ω}_{{k}_{2}} + … + {ω}_{{k}_{m}} ) t}$$

The frequency component, ωₖ₁+ωₖ₂+ . . . +ωₖₘ, and sums and differences between m non-distinct frequencies are generated. There are a total of (2N)^{m} terms. The vector k=(k_{-N}, . . . , k₋₁, k₁, . . . , k_{N}) is a 2N-vector, where element kⱼ denotes the number of times a particular frequency appears in a given term. The sum of the kⱼ must equal m:

$${\sum }_{j = - N}^{N} {k}_{j} = {k}_{- N} + … + {k}_{- 1} + {k}_{1} + … + {k}_{N} = m$$

For a fixed vector k₀, m frequencies can be summed m! ways, but the order of the sum is irrelevant. Since each kⱼ coefficient can be ordered kⱼ! ways, the number of ways to form a given frequency product is given by:

$$( m ; \vec{k} ) = \frac{m !}{( {k}_{- N} ) ! … ( {k}_{- 1} ) ! ( {k}_{1} ) ! … ( {k}_{N} ) !}$$

Since the signal is real, each term has a complex conjugate present. Hence, there is another vector k₀ given by:

$${{k}_{0}^{l}}^{->} = ( {k}_{N} , … , {k}_{1} , {k}_{- 1} , … , {k}_{- N} )$$

The components are in reverse order since ω₋ⱼ=−ωⱼ. If the sum of these two terms is taken, this results in:

2 [symbol] {e^{j(ω}^{ₖ₁}^{+ω}^{ₖ₂}^{+ . . . +ω}^{ₖₘ}^{)t}}=2 cos(ωₖ_{₁}+ωₖ_{₂}+ . . . +ωₖ_{ₘ})t

The amplitude of a frequency product is thus given by:

$$\frac{2 \times ( m ; \vec{k} )}{{2}^{m}} = \frac{( m ; \vec{k} )}{{2}^{m - 1}}$$

For most systems, the dominant non-linearity term is the third-order term. Using the above equation, the amplitude of distortion generated at the input frequency can be computed, input referred, and used to bound the lower allowable limit for P_{-1db} for the entire system. In one embodiment of the invention, the technique presented can be used to optimize the entire system.

In one embodiment of the invention, the algorithm is modified for a direct conversion receiver. In direct conversion or low-IF systems, the distortion generated into low frequency bands can desensitize the receiver and must be taken into account. A simple modification of the above described algorithms can incorporate this element into the algorithm. First note that the overall IIP₂ of the system is given by:

$$\frac{1}{{IIP}_{2 , sys}} = \frac{1}{{IIP}_{2 , 1}} + \frac{{G}_{υ t}}{{IIP}_{2 , 2}} + \frac{{G}_{υ 1} {G}_{υ 2}}{{IIP}_{2 , 3}} + … \frac{{G}_{υ 1} {G}_{υ 2} … {G}_{υ , N - 1}}{{IIP}_{2 , N}}$$

where the voltage gain G_{v,k} is used to input refer the distortion products. Next, two blocking signals that generate in-band distortion are found, or in other words, the intermodulation tone must fall in-band at IF: |f_{B,m}−f_{B,n}|<BW_{IF}. The strength of the IM₂ from these two blockers is input referred:

$${V}_{i n , IM 2} = \frac{{V}_{b 1} {V}_{b 2} {α}_{2}}{{α}_{1}} < {P}_{MDS}$$

where a₁=G_{VT} is the total voltage gain of the system. The above equation is solved for the ratio a₂/a₁, which is the required IIP₂ (voltage):

$${V}_{{IIP}_{2} , min} = \frac{{α}_{1}}{{α}_{2}} .$$

If the search table is augmented to include IIP₂ for a given bias setting (gain distribution), then the search algorithm is modified for this additional check. The following constraints are then used to search the table: G_{T}<G_{T,max}, G_{B,k}<G_{B,k,max} (k=1 . . . K), P_{MDS}<Pᵢₙ, P_{-1dB}>P_{B}, and V_{IIP2}>V_{IIP2,min}. While in most systems second-order distortion generated by two blockers is used to determine the specifications, it is easy to generalize this concept to the intermodulation distortion created by any even power of non-linearity for any number of blockers.

One embodiment of the invention comprises a radio receiver that dissipates low power for ultra low power applications, such as remote wireless sensors. The low power radio architecture can be capable of robust communication and high volume manufacturing. One embodiment of the invention may be a monolithic CMOS radio chip that is optimized for integration with various types of sensors to build wireless sensor devices for remote monitoring. Another aspect of the invention involves three attributes: ultra low power, ultra high reliability and ultra low cost (suitable for volume manufacturing in mainstream CMOS process).

Some embodiments of the invention will be apt to serve a variety of critical applications in industrial, military and consumer applications, particularly relating to sensor networks. In one embodiment, the invention may be used in a wireless physiologic sensors that is connected to mobile devices and used in a variety of healthcare applications relating to the management of diseases, wellness and fitness. The medical care costs of people with chronic diseases alone account for more than 75% of the nation's $1.4 trillion medical care costs, a major problem. The US healthcare system is thus in a state of crisis due to these extraordinarily high costs, and getting worse by the day with baby boomers retiring and obesity rising. In order to lower the cost and maintain the quality of care, the patient must be moved from expensive hospital-based facilities into homes or similar lower cost facilities. This change requires low-cost wireless continuous ambulatory monitoring systems providing clinical visibility to enable the clinician to make the needed diagnostic/therapy changes from a remote location. Many healthcare monitoring systems are semi-wired, unreliable, bulky, power-hungry and expensive, which limits their efficacy and potential for large scale deployment. The present invention can provide a foundation on which other layers of innovative technologies can be laid. An embodiment of the invention may be used in treatment of diabetes, hypertension, circulatory disease, COPD, asthma, CNS disorders, and cardiovascular disease. Some embodiments of the invention can be used to provide low-cost wireless continuous ambulatory monitoring systems providing clinical visibility to enable the clinician to make the needed diagnostic/therapy changes from a remote location.

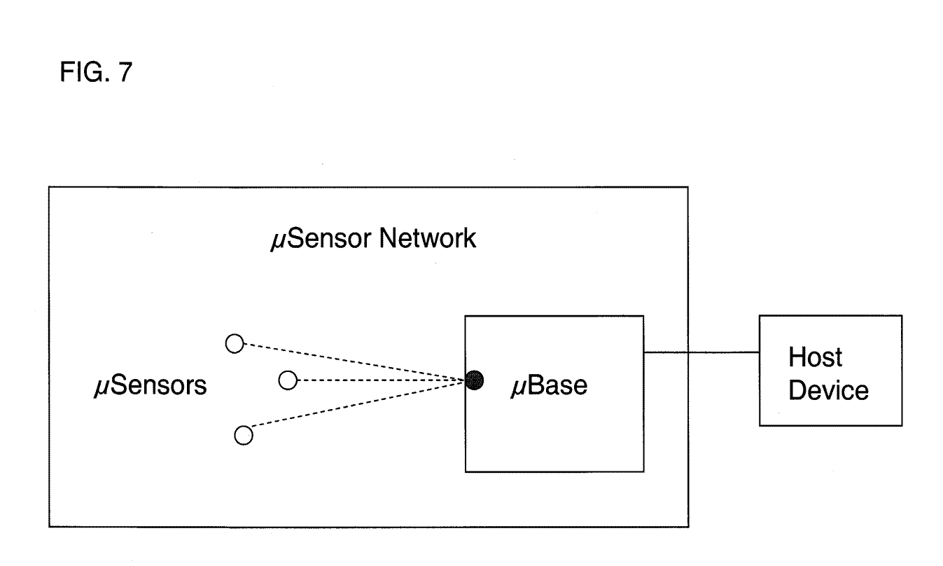

One embodiment of the invention comprises a sensor network as shown in FIG. 7. FIG. 7 illustrates a sensor network comprising μSensors, a μBase and a host device, which may be used for many applications, including a physiological monitoring based healthcare application. The wireless sensors, called μSensors, will typically contain some type of sensor (e.g. physiological, temperature, movement), a radio, a processor and a battery. The μSensors transmit the sensed data to a nearby “microbase” device, called μBase. The μBase contains embodiments of the invention that receive data from multiple μSensors, a processor to further process the data, storage and means to control the network of μSensors. The μBase can reside within a host device or connected to it through a plug-in or a wired bus. Therefore, the μBase can have access to a larger battery than that available to μSensors. Embodiments of the invention can be used in CMOS radio based architecture to serve the critical requirements of μSensors/μBase for the μSensor Network. One embodiment of the invention is a radio receiver used in a μSensor Network that operates at about an aggregate rate of about 1 Mbps to support multiple μSensors, compared with a typical link between a single μSensor and μBase that needs to operate at about 100 Kbps.

Table 3 shows that current commercial radio implementations do not achieve the possible efficiency levels needed for low power radio technology and applications. The majority of “low power” standard based radios require significant power of ˜30 mW, which translates into very poor energy per bit efficiency. Some embodiments of the invention would enable low power radio technology with 5 mW of TX/RX Mode power dissipation, approximate range of 20 m, very low cost, and high reliability that is jam and multi-path resistant.

TABLE 3
Key Metrics of Current Invention and Current Radio Solutions

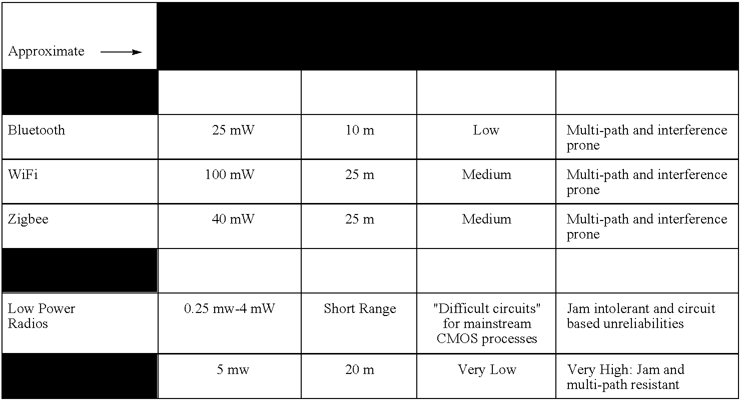

There are many wireless communication standards for short-range communication, but the ones that dominate the marketplace include Wi-Fi (802.11b/g), Bluetooth, and Zigbee. These standard radios do not meet the required functionality for the sensor networks. The Wi-Fi standard was developed for high data rate communication for a wireless LAN operating in the 2.4 GHz ISM band. The data rates vary from 1 Mb/s to 54 Mb/s with a typical range of hundreds of feet for indoor applications. The intended applications of WLAN technology are very different from the requirements of the current invention. Its power consumption is about 100 mW in both transmit and receive mode, which exceeds target requirements by at least over a factor of 20. From radio efficiency perspective, an important metric is the energy per bit, since a WLAN system can be duty cycled to lower the average power consumption. When transmitting 11 Mb/s, the energy consumption is about 9 nJ/bit. For a sensor network around 200 Kb/s, a duty cycling of about 2% can reduce the power consumption to a few milli-watts, in the range of target goal. However, duty cycling trades energy for memory which will be particularly high since the system to store at least 100 times more data and standard Wi-Fi chips does not have provisions for this level of duty cycling. Furthermore, the required software network stack has significant overhead, making it highly inefficient for embedded applications. In other words, for WLAN technology to meet low power, high data and high reliability requirements, this necessitates significant redesign of the technology. In the end, even though the performance may be acceptable, the sensitivity/reliability and output power of a WLAN system exceed our needs by orders of magnitude, so the chip must continually operate in sleep or standby mode, which is inefficient.

A better alternative is a radio designed specifically for short-range communication, or “personal area networking” (PAN). The Bluetooth radio standard was designed with exactly this application in mind. Similar to the Wi-Fi radios (802.11b/g), the radio operates in the 2.4 GHz ISM band. This is a particularly poor choice since this is the most crowded spectrum due to the proliferation of WLAN technology and the overlap with the microwave oven frequency. Frequency hopping is used in Bluetooth to make it more resilient against jamming. The most widely deployed radios have a relatively modest data rate, 723.1 kb/s, which is sufficient for most sensor applications. But this also means that the Bluetooth radio cannot be duty cycled, and most commercial implementations of Bluetooth are relatively power hungry. Most Bluetooth radios consume between 20-30 mW of power in the transceiver alone, which means that the power is much higher at the system level for target application. The software stack for Bluetooth is also sufficiently complicated to make it prohibitive for the target application.

The ZigBee software stack is significantly smaller and simpler, and ZigBee radios typically consume less power than Bluetooth, making it a suitable technology for embedded applications. ZigBee devices conform to the IEEE 802.15.4 Low-Rate Wireless Personal Area Network (WPAN) standard. The radio operates in the unlicensed 2.4 GHz, 915 MHz and 868 MHz ISM bands. In the 2.4 GHz band, there are 16 ZigBee channels, with each channel requiring 5 MHz of bandwidth. The raw data rate in the 2.4 GHz band is 250 kbits/s, and is adequate to the needs of many medical applications. The data rate is lower in the lower bands, 40 kb/s and 20 kb/s in the 900 and 800 MHz ISM bands. The transmit power is around 0 dBm, ideal for a low power radio. But given all of these desirable attributes, most commercial implementations of ZigBee operate at significantly high power, as much as 30-50 mW. This makes ZigBee the least efficient standard in terms of energy per bit, which is surprising since it seems theoretically possible to build a ZigBee transmitter for 3-4 mW.

The majority of “low power” standard based radios require significant power of ˜30 mW, which translates into very poor energy per bit efficiency. The lower bound on power consumption for the ZigBee transmitter can be computed by taking the transmit power (1 mW), dividing by the power amplifier efficiency (50%), which gives 2 mW. The overhead for the driver, frequency synthesizer, and other circuitry needs to be added, which ends up consuming a few additional milli-watts, and so it should be theoretically possible to build a ZigBee transmitter for 3-4 mW. The current commercial radio implementations do not achieve the possible efficiency levels needed for ultra low power radios.

Many research groups have demonstrated extremely low power transmitters for short range applications. See Cook et al. Proc. IEEE International Solid-State Circuits Conference (ISSCC.06), vol. 49, February 2006, pp. 370-1, Chen et al. Proc. IEEE International Solid-State Circuits Conference (ISSCC.06), vol. 49, February 2006, p. 376-7, Vouilloz et al. IEEE J. Solid-State Circuits, vol. 36, no. 3, p. 440.51, March 2001, Joehl et al. IEEE J. Solid-State Circuits, vol. 36, no. 7, p. 1025.31, July 2001, Favre et al. IEEE J. Solid-State Circuits, vol. 33, no. 12, p. 2186.96, December 1998. The power consumption and data rate of several research projects are summarized in Table 4.

TABLE 4
Specifications of select systems

| Power Consumption | Throughput | Reference |
|---|---|---|
| 0.22 mW | 300 kbps | Cook et al. |
| 2.9 mW | 500 kbps | Chen et al. |
| 1.2 mW | 180 kpbs | Vouilloz et al. |
| 3.6 mW | 150 kbps | Joehl et al. |
| 1.2 mW | 100 kbps | Favre et al. |

Four out of the five reported radios are based on the super-regenerative receiver architecture, a very well known technique since the early days of radio. The main problem with super-regenerative receivers is that they rely on positive feedback to realize extremely sensitive front-ends with very little power consumption. While this sounds ideal, the problem is that these radios are very jam intolerant and can easily lock onto another signal. If operated in a crowded ISM band such as 2.4 GHz or 900 MHz, these radios would fail to operate reliably. The only way to overcome this extreme sensitivity is to precede the radio with a very high quality selective filter to knock out all interfering signals. This is the approach proposed by Otis and Rabaey where MEMS technology was used to realize an FBAR selective filter. Otis et al. Proc. IEEE International Solid-State Circuits Conference (ISSCC.05), vol. 48, February 2005, p. 396-7. The MEMS filter adds to the cost of the transceiver but greatly relaxes the requirements of the transceiver. There are other issues with super-regenerative receivers, such as the difficulty of operating at high data rates. While appealing from a pure power consumption perspective, these radios are not sufficiently reliable, cost-effective and flexible for target applications.

The work of Cook and Pister stands out due to its very low sub-milli-watt power consumption. Cook et al. Proc. IEEE International Solid-State Circuits Conference (ISSCC.06), vol. 49, February 2006. Many compromises were made in this design, such as operating on a 400 mV supply. In reality, the rest of the chip will have to operate at a higher voltage to meet the dynamic range requirements. Also, compatibility with common battery cells dictates operation at a higher voltage. So, in essence, this gain in power is artificial unless a 100% efficient switching power supply is employed to drop the main cell down to 400 mV. But switching regulators are noisy, especially problematic in RF applications, and require large inductors, which must be realized off-chip. On another aspect, the raw data rate of 300 kbps is achieved by using a simple FSK modulation scheme with large frequency offset to simplify the detection. When operating in a commercial crowded ISM band, this may not be practical and a real implementation would require frequency hopping, which is likely to increase the power consumption. This radio is also unconventional as it does not employ a front-end low noise amplifier but instead uses passive voltage gain to interface with a CMOS transistor mixer. This approach works only because it drives the gate of MOS device, which is mainly capacitive. But any real world transceiver will require a filter to attenuate out-of-band interferers, which must be terminated with a real 50 ohm resistance. This means that a power hungry matched low noise amplifier (LNA) is required to realize a practical system, which will increase the power even further. Furthermore, in this design, the mixers were driven directly from the VCO, which is not practical due to LO pulling issues from a strong blocker. In reality, an LO buffer is needed to isolate the VCO from the mixer. It is thus clear that the research demonstrations are not practical in many respects, which explains the gap between the practical radios consuming 30 mW or more versus research radios burning only a few mW. Most manufacturers of commercial radios opt for the safe option by using the conventional techniques to implement the front-end radio.

One embodiment of the invention receives an ultra-wideband signal. Ultra-wideband (UWB) radios, historically the first kind of practical radios, have been largely displaced by narrowband radios in the past century. They have resurfaced in recent years due to some of their inherent advantages over narrowband radios. Since they transmit short duration pulses without the use of a carrier, they occupy a large bandwidth. The energy in time is spread in frequency and these systems have the inherent property of “speaking softly” which minimizes interference to other users. In fact, the first generation of systems transmit power below the part 15.509 FCC mask (about −41 dBm/MHz), and thus they can communicate below the noise floor of other electronic equipment. Since the information capacity, given by Shannon's Theorem, is proportional to bandwidth, and only logarithmically related to signal amplitude, it is more power efficient to tradeoff signal amplitude with signal bandwidth. Moreover, UWB radios are less prone to multi-path fading effects since the information is spread over a wide bandwidth. Furthermore, a UWB signal occupying 0-1 GHz bandwidth can easily penetrate through walls and the human body, which makes it more robust for the intended application.

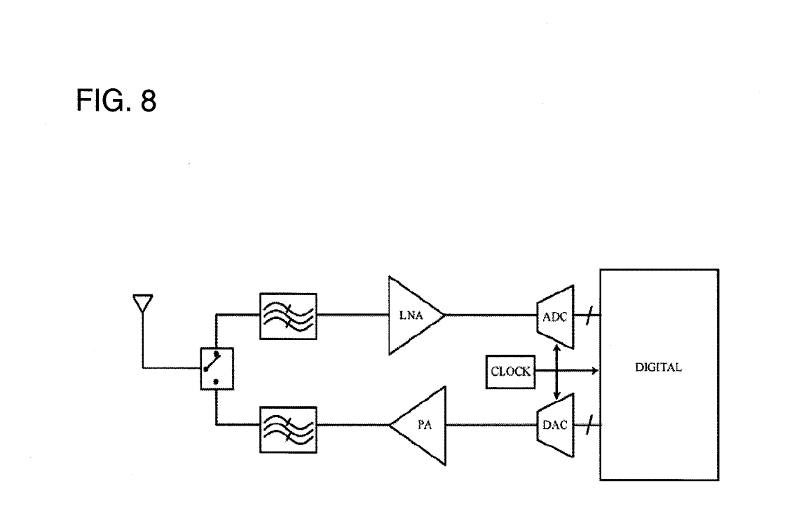

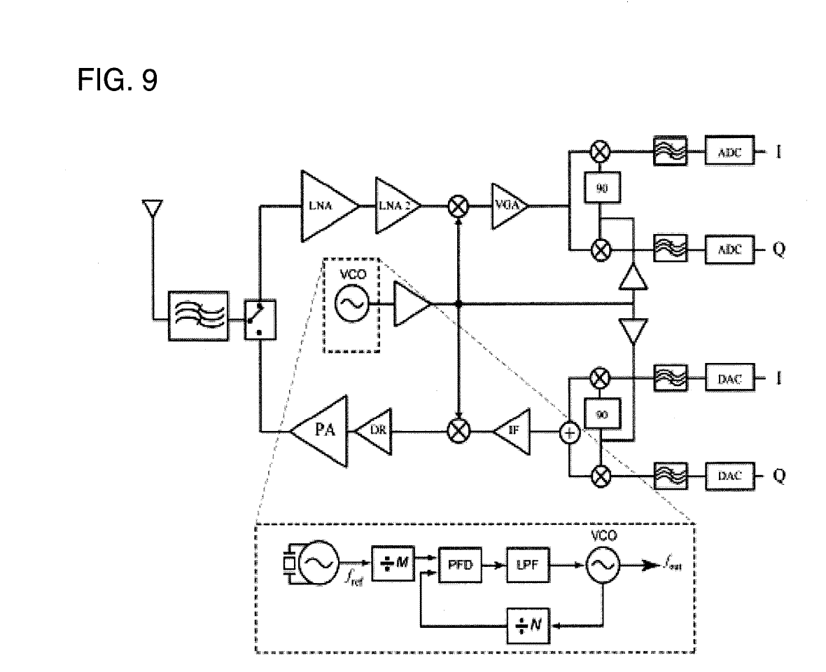

The radio architecture of a UWB radio compared with a traditional narrowband radio is shown in FIG. 8 and FIG. 9. The simplicity of the UWB radio architecture leads one to envision a mostly digital implementation which circumvents the need for a precision RF frequency synthesizer and a down-conversion I/Q mixer. The incoming signal is amplified through a low noise broadband amplifier, sampled, and quantized directly. In a simple oversampled 1-bit architecture, proposed by O'Donnell, a bank of parallel ADCs is used to oversample the signal utilizing a DLL to generate the sampling clock phases. O'Donnell et al. Proc. IEEECAS Workshop on Wireless Communications and Networking, Pasadena, Calif., September 2002. The transmitter is also much simpler and utilizes a digital pulse generator, circumventing the frequency synthesizer, single-sideband up-conversion mixer, and power amplifier. This is especially important since the power amplifier is typically the bottleneck in narrowband low power systems, with typical efficiencies of 30%-50% for a 1 mW transmitter, setting the lower bound on the power consumption of the transmitter. A UWB transmitter, realizable as an H-bridge, exploits the fast clock edge in a modern CMOS process to generate a pulse. The antenna impedance is absorbed into the H-bridge to generate the appropriate pulse shape to meet the FCC mask.

Recently O'Donnell demonstrated a functional UWB radio implemented in low-cost CMOS technology with the capability to transmit and receive at a rate of 1 Mpulses/s while consuming 1 mW. The radio can transmit 32 Mpulses/s while only consuming 8 mW. The radio operated in the 0-1 GHz band and in the spirit of the IEEE 802.15.4a standard. The Orthogonal Frequency Division Multiplexing (OFDM) style UWB radios can be distinguished from a pulse-based radio. The OFDM radio has been proposed as an alternative to the pulse based system which allows high data rate communication using techniques very similar to existing wireless standards (such as WLAN 802.11a/g). These systems are intended for high data rate applications and are power hungry due to the required baseband processing. The radio frequency front-end for these systems is also complicated by the need for fast frequency hopping precluding a traditional PLL based frequency synthesizer. The term UWB refers to the classical sense of pulse based communication.

Another embodiment of the invention is a low cost, low power, highly reliable radio that uses UWB technology. UWB radios save power and cause minimum interference to other users of the spectrum. This is especially attractive since a network of μSensors can coexist and easily share the spectrum. However, these radios must comply with FCC regulations and limit their transmit power to −41.3 dBm/MHz, which can severely limit the communication range. Coexistence with narrowband radios is another threat, since strong interfering signals have the potential to jam a UWB radio and render it inoperable. Thus, a UWB radio link can be lost due to jamming and increased distance between μSensors/μBase. If an outage occurs, one cannot completely rely on the link and network layers to assist in recovering lost packets due to potentially limited memory on a μSensor. An outage may exist for a sufficiently long time as to completely fill up the queue of information to be transmitted.

In one aspect of the invention, the radio scheme can behave mostly like a UWB radio, but can change its behavior to a narrowband radio in case of UWB link outages (potentially rare occurrences). It minimizes power consumption by mostly operating in a UWB mode. If UWB link outage occurs, it can dynamically adapt narrowband radio behavior to reestablish the link, resulting in very high link robustness, and therefore very high reliability. Such a radio can be attractive from a manufacturing perspective since it can use proven techniques of narrowband and UWB designs. One aspect of the invention comprises radio optimization that can support two radio behaviors in a practical CMOS implementation. Another aspect of the invention is a system level algorithm for automatically switching radio behavior based on the prevailing radio environment, without user intervention.

Other aspects of the invention comprise a front end physical layer design (RF/baseband). Another aspect of the invention involves implementation of RF/analog blocks for the RF transceiver. One aspect of the invention includes upper layers (data link and network layers). Another aspect of the invention involves radio behavior adaptation where an algorithm can automatically select a radio behavior for the prevailing RF environment, and accordingly switch the radio behavior without any data loss.

One embodiment of the invention comprises computationally asymmetrical μSensors/μBase sensor networks. For example, the μBase can afford higher power dissipation than μSensors due to its access to a potentially larger battery. Therefore, it can have relatively higher complexity processor which can be utilized to ease the burden on μSensors by using radio schemes that leverage such asymmetry. For example, the radio behavior selection algorithms will run on μBase that will fully control μSensors. In one aspect, the radio receiver can achieve the record performance approaching the targets set in Table 3 in terms of power, reliability and range.

One embodiment of the invention comprises a narrow-band, ultra low-power radio. For such functionality, the key building blocks in the receiver include a low noise amplifier (LNA), two I/Q mixers, a frequency synthesizer, analog-to-digital converter and the VGA. In a typical ZigBee radio, the power consumption of these blocks can exceed 30 mW, with the bulk of the power going to the frequency synthesizer PLL for good frequency stability and low phase noise and to the LNA to realize low noise figure. In one embodiment of the invention, a trade-off can be made with the required performance specifications to lower the power consumption of the radio. Many interesting schemes for various low power and low noise building blocks have been reported in the literature. See Bruccoleri et al. IEEE Journal of Solid-State Circuits, vol. 39, February 2004, p. 275-282, Shahani et al. IEEE Journal of Solid-State Circuits, vol. 32, December 1997, p. 2061-2070, Chien et al. Digest of Technical Papers, International Solid-State Circuits Conference, San Francisco, Calif. Feb. 8, 2000, Wang et al. IEEE Journal of Solid-State Circuits, vol. 41, November 2006, p. 2449-2456, Bevilacqua et al. IEEE Int. Solid-State Circuits Conf. Dig. Tech. Papers, 2004, Wang et al. IEEE Journal on Selected Areas in Communications, vol. 24, April 2006, p. 871-877. Noise cancellation can be used as a very effective technique for the realization of broadband low noise amplifiers. See Bruccoleri et al. More importantly, this technique allows one to use “noisy” techniques for an input match while using the noise cancellation to improve the sensitivity of the receiver.

A UWB radio behavior can be integrated by using the schemes similar to the radio demonstrated by O'Donnell, consuming 1 mW of average power. When operating in the lower frequency bands from 100 MHz-900 MHz, an ultra wideband radio can be designed with minimal tuning elements such as inductors and operate at very low power levels. A major challenge is to combine this range of radio behaviors in a single architecture by minimizing the complexity of the basic building blocks such as LNA, the DLL, the samplers and mixers, leading to small die area and ultra low power consumption. Regarding A/D conversion, a sigma-delta oversampled ADC architecture offers flexible dynamic range by adjusting the oversampling rate. This can accommodate low rate sensor signals at low power and higher data rate sensor signals by increasing the oversampling ratio.

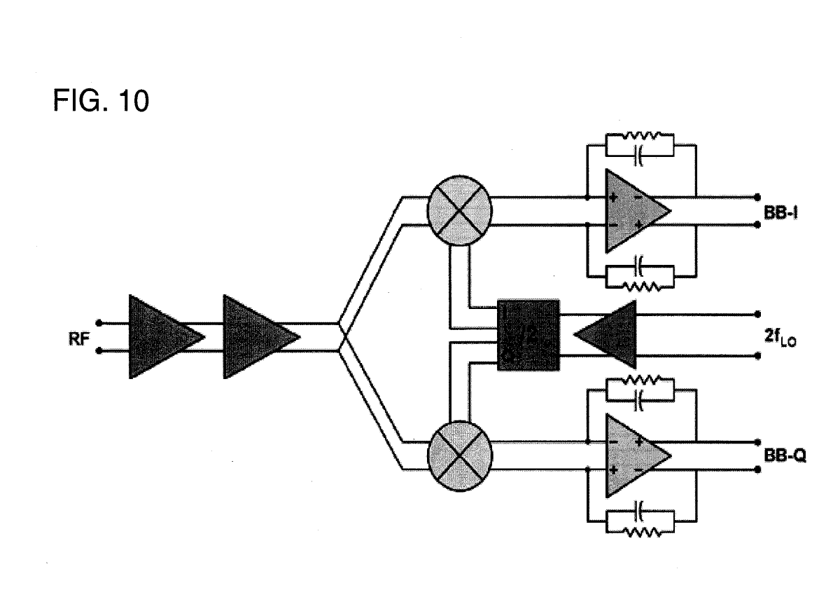

One embodiment of the invention comprises architecture based on a Cognitive Universal Radio (COGUR), shown in FIG. 10. Basic RF building blocks such as the LNA, mixer, PA, and synthesizer are broadband and dynamic, which allows them to be deployed for various applications and frequency bands. For instance, a noise cancelling LNA described in Chen et al. uses an auxiliary amplifier for noise and distortion cancellation. When this device is turned on, the LNA has low noise figure and high linearity over a broad frequency range of 0.5 GHz-2.5 GHz but consumes a large power. When this device is turned off, the power consumption is reduced to 10% while the noise figure and linearity suffer. This dynamic architecture allows one to deploy a low power radio that can function 90% of the time in low power mode, but can increase the power to cope with blocking/interfering signals in the rare circumstance. Likewise, several of years of research on passive CMOS mixers has resulted in a simple broadband current mode passive mixer architecture that has excellent 1/f noise (due to the low current in the switching quad), with a programmable output filter that can easily accommodate different bandwidth requirements in the system. Given that the LO power is the dominant power loss in a passive mixer, a dynamic LO buffer is proposed to only deliver the needed amplitude for the best conversion gain and noise figure. In many scenarios, though, the LO power can be reduced substantially if the received SNR is high enough, resulting in a large power savings. Current mode operation in the mixer allows one to retain high dynamic range even with a low supply voltage of 1V, md current to voltage conversion only happens after filtering, which relaxes the dynamic range requirements of the baseband.

One embodiment of the invention is a software defined radio with different RF and IF frequency bands which calls for a wide tuning range VCO and programmable frequency synthesizer. One aspect of the invention involves a VCO architecture that is able to tune over a very wide range without incurring high current at the extreme ends of the range due to Q variation across the band. This architecture uses a digital mixed-signal amplitude calibration loop that can be optimized to deliver the required current over a wide tuning range of the VCO, without wasting power. The VCO can be optimized for phase noise or power consumption dynamically, depending on the application. The baseband low-IF bandwidth can be adjusted using a switched capacitor op-amp RC filter stage to accommodate various data rates.

One aspect of the invention comprises a novel transformer based power combining scheme, similar to the Distributed Active Transformer proposed by Aoki. See Aoki et al. IEEE Journal of Solid-State Circuits, March 2002, vol. 37, issue 3, p. 371-383. Transformer power combining allows efficient on-chip power combining, high output power levels using low voltage technology, and impedance matching. A prototype demonstrated 27 dBm of saturated output power with 32% efficiency at 2.4 GHz and 24 dBm of linear output power using a conventional 1.2 V 0.13 um CMOS process. Liu et al. Proceedings of CICC, 2006, p. 141-144. More importantly, the prototype is capable of switching off output power stages using a novel resonant switching scheme, which allows the PA to recover efficiency at power back-off, similar to a Doherty amplifier. This is critical in a dynamic environment when the PA must function primarily in power back-off mode, and only switch to high power mode in a rare circumstance. A novel figure-eight transformer was proposed which led to the demonstration of a 24 dBm CMOS PA operating on a 1V supply at 5.8 GHz in a 90 nm process with 27% efficiency. Haldi et al. RFIC 2007, p. 431-434. The figure-eight transformer is ideal for the realization of an efficient on-chip transformer structure with lateral coupling, and the structure is easily integrated in any CMOS process. Both power amplifiers demonstrated linear performance at power back-off due to the class AB biasing used.

One embodiment of the invention comprises the above building blocks, which can be integrated into a software defined radio front-end with wideband operation (0.5 GHz-5 GHz), dynamic power consumption and performance, and variable IF bandwidth for varying data rates. The building blocks are compatible with standard CMOS technology. In low power mode, the radio will consume only 2 mW. In peak power mode, the power consumption for the LNA, mixer, and LO path is estimated to be 30 mW. But this level of performance will only be needed for the full sensitivity (NF ˜2 dB, IIP3 ˜−10 dBm), and dramatically lower power can be delivered if one is willing to trade-off performance. Table 5 below summarizes the performance of the proposed system in the various modes of operation.

TABLE 5
Performance specifications of the proposed radio

| | | | Low | | UWB | | Medium | | High | |
|---|---|---|---|---|---|---|---|---|---|---|
| | Sleep | | Power | | Mode | | Power | | Power | |
| RX Power | 0.3 | mW | 2 | mW | 2 | mW | 5 | mW | 24 | mW |
| TX Power | 0 | mW | 2 | mW | 1 | mW | 10 | mW | 200 | mW |
| Data Rate | 1 | kb/s | 100 | kb/s | 1 | Mb/s | 2 | Mb/s | 10 | Mb/s |
| Noise Figure | 12 | dB | 5 | dB | 4 | dB | 3 | dB | 2 | dB |
| RX IIP3 | −25 | dBm | −15 | dBm | −10 | dBm | −10 | dBm | −3 | dBm |
| Sensitivity | −124 | dBm | −111 | dBm | −71 | dBm | −100 | dBm | −94 | dBm |
| Energy/bit(nJ/bit) | 300 | | 20 | | 2 | | 2.5 | | 2.4 | |

The breakdown in the power dissipation of the receiver is summarized in Table 6.

TABLE 6
Power dissipation of the proposed radio.

| | | | Low | | UWB | | Medium | | High | |
|---|---|---|---|---|---|---|---|---|---|---|
| | Sleep | | Power | | Mode | | Power | | Power | |
| LNA | 0 | mW | 0.6 | mW | 1 | mW | 2 | mW | 10 | mW |
| Mixer (+LO) | 0.1 | mW | 0.2 | mW | 0 | mW | 1 | mW | 5 | mW |
| Synthesizer | 0.1 | mW | 1 | mW | 0.5 | mW | 1.5 | mW | 5 | mW |
| Baseband | 0.1 | mW | 0.2 | mW | 0.5 | mW | 0.5 | mW | 4 | mW |
| Filter | | | | | | | | | | |

Some embodiments of the invention may be used in healthcare wireless technology. At present, the whole health care industry is primarily reactive and focused on responding to symptoms and disease manifestations only when poor health arises to a level of significance. While serving the purpose in many cases, this approach is expensive and inefficient due to the delayed response, i.e., therapy starting well after the diseases started affecting the health significantly. With the rise in chronic diseases and their associated complications, there is a need to change this reactive mindset of both patients and clinicians. According to the Centers for Disease Control and Prevention (CDC), more than 90 million Americans currently live with chronic illnesses, with chronic diseases accounting for 70% of all deaths in the United States. The medical care costs of people with chronic diseases account for more than 75% of the nation's $1.4 trillion medical care costs. The current invention can be applied to address a large portion of this huge market over time. Seventy eight million retiring baby-boomers, who are spending power over $2 Trillion, are even more poised to use the technology solutions such as the current invention to live independently.

Some embodiments of the invention may be used in treating various diseases. Over the last century, the leading cause of death dramatically changed from acute to chronic diseases. As chronic diseases have emerged as the principal medical problem, early detection and rapid intervention have become significant because of the impact they can have on the quality of life and health care costs. In order to move the patient and the clinician away from the classical acute hospital care approach and to facilitate early intervention, a system is needed that provides cheaper home or nursing home equipment with continuous wireless monitoring capabilities and clinical visibility (monitoring) to enable the clinician to have the requisite data to make such diagnostic/therapy changes from a remote location. Earlier intervention that is cost effective requires remote monitoring, and the current hospital setup, although it does not preclude early detection, is not cost efficient. Remote monitoring requires continuous, low cost devices to provide the requisite clinical visibility (sensitivity and specificity). Continuous monitoring also requires wireless/on-body/wearable devices.

Given this background, the focus on fully ambulatory, continuous monitoring therapy management systems enabled by wireless communication is rapidly increasing. Various studies are being published to show the efficacy of remote and continuous monitoring. Rothman, Laughlin et al. J. Cardiovasc Electrophysiol 18(3): 241-7, NEHI, July 2004, NEHI, March 2005. However, the lack of low cost, robust advanced wireless technology platforms has delayed the introduction of ambulatory, continuous monitoring, low cost medical device technologies for chronic disease and therapy management. This lack of technology created a large void between expensive in-hospital wired continuous monitoring equipment and at-home low functionality diagnostic equipment. Use of embodiments of the invention in a wireless semiconductor platform will enable the development of safe, high quality, ambulatory, and low cost disease management tools. It can give patients freedom, control, convenience, and higher compliance. Other benefits include convenience and better diagnostic/treatment by physicians which leads to better outcome. Another benefit would be lower cost for payers. The invention also has potential use in treatment of diabetes, hypertension, circulatory disease, COPD, asthma, CNS disorders, and cardiovascular disease. The invention may also be used in non-healthcare markets that may include various applications in military, industrial and consumer markets.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A front end radio receiver comprising a series of programmable blocks wherein each block is adjustable over a series of values by varying a control signal to the block, wherein the programmable blocks comprise a low noise amplifier (LNA) and one or more of:
a mixer or a sampler;
a local oscillation (LO) buffer;
a voltage controlled oscillator (VCO);
a variable gain amplifier (VGA) or a programmable gain amplifier (PGA);
an intermediate frequency (IF) bandpass filter; or
an analog to digital converter (ADC).

2. The front end radio receiver of claim 1 further comprising a computational device that determines the control signal to each of the blocks.

3. The front end radio receiver of claim 2 wherein the control signal to each of the blocks is varied based, at least partially, on a received signal strength.

4. The front end radio receiver of claim 2 wherein a computational device determines a blocking signal profile and determines the control signal to each block based on the blocking signal profile.

5. The front end radio receiver of claim 4 wherein a blocking signal profile comprises a blocking signal strength indicator (BS SI) and a list of blockers including blocker frequency and blocker signal strength.

6. The front end radio receiver of claim 1 wherein the control signal comprises a bias current or a bias voltage that modulates the DC power consumption of one or more of the programmable blocks.

7. The front end radio receiver of claim 1 wherein the control signal is an analog signal.

8. The front end radio receiver of claim 1 wherein the control signal is a digital signal.

9. The front end radio receiver of claim 1 wherein the radio receives an ultra-wideband signal.

10. The front end radio receiver of claim 1 wherein the radio receives a narrowband signal.

11. A front end radio receiver comprising a series of programmable blocks wherein each block is adjustable over a series of values by varying a control signal to the block, wherein the programmable blocks comprise a low noise amplifier (LNA) and one or more of:
a mixer with a local oscillation (LO) buffer; and
a variable gain amplifier (VGA).

12. A method for controlling power consumption of a radio that receives an input signal comprising:
(a) receiving the input signal;
(b) determining an input signal strength;
(c) detecting a presence and characteristics of one or more blocking signals;
(d) determining a set of control signals to be delivered to a series of programmable blocks based on the input signal strength and the presence and characteristics of the blocking signal, wherein the programmable blocks comprise a low noise amplifier (LNA) and one or more of:
a mixer or a sampler;
a local oscillation (LO) buffer;
a voltage controlled oscillator (VCO);
a variable gain amplifier (VGA) or programmable gain amplifier (PGA);
an intermediate frequency (IF) bandpass filter; or
an analog to digital converter (ADC); and
(e) delivering a set of control signals to the programmable blocks such that power consumption of the radio is controlled.

13. The method of claim 12 wherein the detecting of the presence and characteristics of a blocking signal is performed by a baseband scanner or an ADC resolution sweep.

14. The method of claim 12 wherein determining the set of control signals to be delivered to the programmable blocks is performed using a search table, a set of input values, and a set of constraints.

15. The method of claim 14 wherein the search table comprises a series of entries, each entry comprising at least a total system gain, a gain distribution comprising a gain for each of the programmable blocks, and a total power consumption.

16. The method of claim 14 wherein an input value comprises one or more of a required signal to noise ratio, a signal strength value, an ADC full scale power value, a blocker frequency offset value, or a blocker power level.

17. The method of claim 14 wherein a constraint is placed on a total gain value, a minimum detectable signal power value, a gain at a blocker frequency, or a compression point value.

18. The method of claim 15 wherein the entries of the search table are calculated using a method which determines an optimal set of control signals in order to minimize power consumption while meeting the required specifications of the receiver.

19. The method of claim 12 wherein in step (c), it is determined that there are no blocking signals and determining the set of control signals to be delivered to the programmable blocks is performed by applying inputs for required signal to noise ratio, signal strength, and ADC full scale power comprising:
(i) setting a quantization noise floor value;
(ii) calculating a maximum allowed total gain value to avoid saturating the ADC, and calculating a minimum gain value required to raise the input signal above an ADC noise floor;
(iii) calculating a compression point value, P_{-1dB};
(iv) searching the search table and listing as a possible solution each entry that meets the constraint of (A) a total gain value greater than or equal to a minimum total gain value and less than or equal a maximum total gain value, and (B) a minimum detectable signal power value that is greater than an input power value;
(v) checking whether an entry that is listed as a possible solution has an ADC resolution that is the highest supported;
(vi) repeating steps (iv) and (v) until an entry listed as a possible solution has an ADC resolution that is the highest supported;
(vii) choosing an entry with the lowest total power consumption; and
(viii) delivering a set of control signals to the programmable blocks from the entry chosen in step (vii).

20. The method of claim 12 wherein in step (c), it is determined that there is one dominant blocking signal in a channel with no in-band intermodulation product, and determining the set of control signals to be delivered to the programmable blocks is performed by applying inputs for required signal to noise ratio, signal strength, ADC full scale power, blocking signal power, and blocking signal frequency comprising:
(i) calculating a minimum required bits in ADC;
(ii) calculating a maximum allowed total gain value to avoid saturating the ADC, a maximum allowed gain in the blocking signal channel, a quantization noise floor value, and a minimum gain value to raise the signal out of the ADC noise floor;
(iii) calculating a compression point value, P_{-1dB}, to correspond to power of the blocking signal;
(iv) searching the search table and listing as a possible solution each entry that meets the constraint of (A) a total gain value greater than or equal to a minimum total gain value and less than or equal to a maximum total gain value, (B) a gain in the blocking signal channel that is less than or equal to a maximum allowed gain in the blocking signal channel, (C) a power at the blocking signal channel that is less than or equal to the compression point value, and (D) a minimum detectable signal power value that is less than or equal to the input power value;
(v) checking whether an entry that is listed as a possible solution has an ADC resolution that is the highest supported;
(vi) repeating steps (iv) and (v) until an entry listed as a possible solution has an ADC resolution that is the highest supported;
(vii) choosing the entry with the lowest total power consumption; and
(viii) delivering the set of control signals to the programmable blocks from the entry chosen in step (vii).

21. The method of claim 12 wherein in step (c), it is determined that there is more than one dominant blocking signal in a channel with no in-band intermodulation product, and determining the set of control signals to be delivered to the programmable blocks is performed by applying inputs for required signal to noise ratio, signal strength, ADC full scale power, and a list of blocker power levels and frequencies, wherein the power level and frequency of a largest blocker is identified, comprising:
(i) calculating a minimum required bits in ADC to process the largest blocker and the input signal;
(ii) calculating a maximum allowed total gain value to avoid saturating the ADC, a quantization noise floor value, and a minimum gain value to raise the signal out of the ADC noise floor;
(iii) calculating a compression point value, P_{-1dB};
(iv) searching the search table and listing as a possible solution each entry that meets the constraint of (A) a total gain value greater than or equal to a minimum total gain value and less than or equal to a maximum total gain value, (B) a value of the gain at the blocking signal channel multiplied by a power of the blocker that is less than or equal to an ADC full scale power for all blockers, (C) a power level at the frequency of the largest blocker that is less than or equal to the compression point value, and (D) a minimum detectable signal power value that is less than or equal to the input power value;
(v) checking whether an entry that is listed as a possible solution has an ADC resolution that is the highest supported;
(vi) repeating steps (iv) and (v) until an entry listed as possible solutions has an ADC resolution that is the highest supported;
(vii) choosing the entry with the lowest total power consumption; and
(viii) delivering the set of control signals to the programmable blocks from the entry chosen in step (vii).

22. The method of claim 12 wherein in step (c), it is determined that there is a high IF system with more than one dominant blocking signal in a channel and an in-band intermodulation product, and determining the set of control signals to be delivered to the programmable blocks is performed by applying inputs for required signal to noise ratio, signal strength, ADC full scale power, and a list of blocker power levels and frequencies, wherein the power level and frequency of two largest blockers is identified, comprising:
(i) calculating a minimum required bits in ADC to process the largest blocker and the input signal;
(ii) calculating a maximum allowed total gain value to avoid saturating the ADC, a quantization noise floor value, and a minimum gain value to raise the signal out of the ADC noise floor;
(iii) calculating a compression point value, P_{-1dB}, set by the two largest blockers which create an in-band distortion product;
(iv) searching the search table and listing as a possible solution each entry that meets the constraint of (A) a total gain value greater than or equal to a minimum total gain value and less than or equal to a maximum total gain value, (B) a value of the gain at the blocking signal channel multiplied by the power of the blocker that is less than or equal to an ADC full scale power for all blockers, (C) a power level at the frequency of the largest blocker that is less than or equal to the compression point value, and (D) a minimum detectable signal power value that is less than or equal to the input power value;
(v) checking whether an entry that is listed as a possible solution has an ADC resolution that is the highest supported;
(vi) repeating steps (iv) and (v) until an entry listed as possible solutions has an ADC resolution that is the highest supported;
(vii) choosing the entry with the lowest total power consumption; and
(viii) delivering the set of control signals to the programmable blocks from the entry chosen in step (vii).

23. The method of claim 12 wherein in step (c), it is determined that there is a low IF system or a direct conversion system with more than one dominant blocking signal in a channel and an in-band intermodulation product, and determining the set of control signals to be delivered to the programmable blocks is performed by applying inputs for required signal to noise ratio, signal strength, ADC full scale power, and a list of blocker power levels and frequencies, wherein the power level and frequency of two largest blockers is identified, comprising:
(i) calculating a minimum required bits in ADC to process the largest blocker and the input signal;
(ii) calculating a maximum allowed total gain value to avoid saturating the ADC, a quantization noise floor value, and a minimum gain value to raise the signal out of the ADC noise floor;
(iii) calculating a compression point value, P_{-1dB}, set by the two largest blockers which create an in-band distortion product;
(iv) searching the search table and listing as a possible solution each entry that meets the constraint of (A) a total gain less than a maximum total gain value, (B) a gain in the blocking signal channel that is less than a maximum allowed gain in the blocking signal channel, (C) a power level at the frequency of the largest blocker that is less than the compression point value, (D) a minimum detectable signal power value that is less than the input power value, and (E) a voltage second-order intercept point value that is greater than a required minimum voltage second-order intercept point value;
(v) checking whether an entry that is listed as a possible solution has an ADC resolution that is the highest supported;
(vi) repeating steps (iv) and (v) until an entry listed as possible solutions has an ADC resolution that is the highest supported;
(vii) choosing the entry with the lowest total power consumption; and
(viii) delivering the set of control signals to the programmable blocks from the entry chosen in step (vii).
